(19) United States
(12) Patent Application Publication
(10) Pub. No.: US 2011/0091626 A1
(43) Pub. Date: Apr. 21, 2011

(54) WHEAT FLOUR SUBSTITUTE FOR BAKERY FOODS AND BAKERY FOODS PREPARED USING THE SAME

(75) Inventors: Makoto TACHIBE, Itami-shi (JP); Shozo SUGANO, Takarazuka-shi (JP); Nobuyoshi ASAYAMA, Takarazuka-shi (JP)

(73) Assignee: Matsutani Chemical Industry Co., Ltd., Itami-shi (JP)

(21) Appl. No.: 12/966,791

(22) Filed: Dec. 13, 2010

Related U.S. Application Data
(63) Continuation of application No. 11/875,509, filed on Oct. 19, 2007.

(30) Foreign Application Priority Data
Oct. 20, 2006 (JP) 2006-286077

(51) Int. Cl. A21D 2/18

(52) U.S. Cl. 426/496

(57) ABSTRACT

The present invention provides a method of improving quality of bread containing a swelling-controlled starch, comprising replacing 20-70% of wheat flour with a wheat flour substitute, wherein said wheat flour substitute comprises a swelling-controlled starch and a swelling-control free starch.

### TECHNICAL FIELD

The present invention relates to a wheat flour substitute for bakery foods comprising swelling-controlled starch and swelling-control free starch and bakery foods prepared using the wheat flour substitute, which are improved in the bread-making ability, the palatability, and the taste and texture of the resulting foods.

### BACKGROUND ART

The term “dietary fiber” is a general term for the components present in the foods, which are not digestible even by the action of any human digestive enzyme. The dietary fibers are roughly divided into water-soluble dietary fibers (hereunder referred to as “SDF”) which are soluble in water and water-insoluble dietary fibers (hereunder referred to as “IDF”) which are insoluble in water and these two kinds of dietary fibers show different physiological functions within the living bodies, respectively. Accordingly, these SDF and IDF components are separately described in the “Standard tables of food composition” and the total quantity of components belonging to these two divisions: SDF and IDF are likewise disclosed in the food standard table as the total dietary fibers (hereunder referred to as “TDF”).

Examples of such physiological functions of dietary fibers are as follows: It has been known that SDF is quite susceptible to fermentation in the large intestines and the products thus formed through the fermentation are effectively used; and it has likewise been reported that IDF plays a principal role in the excretion-promoting effects. In addition, it has been known that an increase of the amount of TDF intake would promote the movement of the intestinal contents and as a result, TDF serves to control the onset of large-intestinal carcinoma and to control the diverticular disease of the colon (5-th Revision of Standard tables of food composition in Japan, 2001). As has been discussed above, the dietary fibers show a variety of effects and they have been regarded as quite important as a “6-th nutrient” subsequent to the five principal nutrients.

On the other hand, swelling-controlled starch products having a high TDF content have been put on the market, by various companies, in response to the recent increase in the health-orientation. As methods for controlling the swelling of the starch, there have been used, for instance, one in which starch is subjected to a phosphate-crosslinking treatment (see Patent Document 1); one which comprises the step of subjecting the starch to a wet-heat treatment (see Non-Patent Document 1); and one which comprises the selection and use of starch materials each having a high amylose content. The starch products prepared by such methods are limited in the swelling thereof through heating and therefore, the content of IDF present therein increases, while they are almost free of SDF.

There have likewise been proposed techniques for applying such swelling-controlled starch materials to bakery foods. For instance, Patent Document 1 discloses foods containing phosphate-crosslinked starch materials, in particular, leavened foods including bakery foods.

The swelling-controlled starch would be incorporated into bakery foods mainly in order to increase the dietary fiber content in the final product. In case where the swelling-controlled starch material is incorporated into a bakery food in a large amount, however, the resulting final product suffers from problems such that it has a powdery taste and texture and tastes bad. In addition, other problems also arise such that the dough is quite sticky upon the production of various bakery foods and that the resulting dough is insufficient in the viscoelasticity and extensibility.

For instance, Patent Document 2 discloses bread characterized in that it is produced using a principal ingredient for producing breads or a raw powder which comprises 55 to 90 parts by mass of wheat flour and 45 to 10 parts by mass of crosslinked starch whose degree of swelling falls within the range of from 3 to 15 and whose solubility is not more than 15% by mass. When manufacturing, by way of trial, bread containing only phosphate-crosslinked starch, incorporated therein, as a starch material, the product finally obtained suffers from problems such that it has powdery taste and texture and that it tastes bad or has unpleasant flavor.

Moreover, Patent Document 3 discloses breads and bread crumbs produced using starch subjected to a wet heat-treatment. However, this production method suffers from problems such that the dough is quite sticky upon the production of breads and that the resulting dough is insufficient in the viscoelasticity and extensibility. In addition, the final product suffers from problems such that it has powdery taste and texture and that it tastes bad or has unpleasant flavor, as in the case where the phosphate-crosslinked starch materials are used.

On the other hand, Patent Document 4 discloses noodles or vermicelli characterized in that they comprise cereal powder and resistant starch-containing starch having a resistant starch content of not less than 60% by mass. In addition, this document also discloses that the resistant starch-containing starch preferably used therein includes wet heat-treated starch materials derived from corn starch and/or derivatives thereof having a high amylose content. However, this document does not include any disclosure concerning the bakery foods.

Patent Document 5 discloses a method for manufacturing confectionary characterized in that, upon the production of confectionary which comprises wheat flour, as a main ingredient, the method uses wheat flour, 10 to 80% by mass of which is replaced with a mixture of hydroxypropyl starch and/or acetyl starch having a degree of substitution (DS) ranging from 0.01 to 0.15, and swelling-controlled starch in a ratio ranging from 10:90 to 90:10, wherein the degree of substitution of the raw flour including the wheat flour is adjusted in such a manner that it falls within the range of from 0.001 to 0.03. However, this document does not include any disclosure about bakery foods.
Patent Document 1: JP-A-2002-503959;
Patent Document 2: Japanese Patent No. 3,723,860;
Patent Document 3: JP-A-6-169680;
Patent Document 4: JP-A-10-313804;
Patent Document 5: Japanese Patent No. 3,488,935;
Non-patent Document 1: Starch Science, 1993, 40 (No. 3): 285-290.

### DISCLOSURE OF THE INVENTION

### Problems that the Invention is to Solve

Accordingly, it is an object of the present invention to provide a wheat flour substitute for bakery foods and bakery foods prepared using the same. It is another object of the present invention to improve the fabricability of a bakery food obtained using swelling-controlled starch, and the taste and texture, and palatability of the final product.

### Means for Solving the Problems

The foregoing objects of the present invention can be accomplished by the simultaneous use of swelling-controlled starch and swelling-control free starch when producing a bakery food containing such swelling-controlled starch incorporated therein. The inventors of this invention have conducted various studies to solve the foregoing problems associated with the conventional bakery foods, have found that the problems can be solved by the use of swelling-controlled starch and swelling-control free starch in combination and have thus completed the present invention.

According to the present invention, there are thus provided a wheat flour substitute for bakery foods and a bakery food prepared using the same, as will be detailed below:

1. A wheat flour substitute for bakery foods comprising swelling-controlled starch and swelling-control free starch.
2. The wheat flour substitute for bakery foods as set forth in the foregoing item 1, wherein the degree of swelling of the swelling-controlled starch is not more than 10.
3. The wheat flour substitute for bakery foods as set forth in the foregoing item 1, wherein the degree of swelling of the swelling-controlled starch is not more than 5.
4. The wheat flour substitute for bakery foods as set forth in any one of the foregoing items 1 to 3, wherein the swelling-controlled starch is phosphate-crosslinked starch or wet heat-treated starch.
5. The wheat flour substitute for bakery foods as set forth in any one of the foregoing items 1 to 4, wherein the degree of swelling of the swelling-control free starch is not less than 15.
6. The wheat flour substitute for bakery foods as set forth in the foregoing item 5, wherein the swelling-control free starch is at least one member selected from the group consisting of hydroxypropyl starch, hydroxypropylated phosphate-crosslinked starch, starch acetate, acetylated phosphate-crosslinked starch, and oxidized starch.
7. The wheat flour substitute for bakery foods as set forth in the foregoing item 5 or 6, wherein the swelling-control free starch is hydroxypropyl starch and/or hydroxypropylated phosphate-crosslinked starch.
8. The wheat flour substitute for bakery foods as set forth in any one of the foregoing items 1 to 7, wherein the mixing ratio of the swelling-controlled starch to the swelling-control free starch ranges from 10:90 to 80:20.
9. The wheat flour substitute for bakery foods as set forth in the foregoing item 8, wherein the mixing ratio of the swelling-controlled starch to the swelling-control free starch ranges from 20:80 to 50:50.
10. The wheat flour substitute for bakery foods as set forth in any one of the foregoing items 1 to 9, wherein wheat gluten is incorporated into the wheat flour substitute for bakery foods which comprises the swelling-controlled starch and the swelling-control free starch.
11. A bakery food produced using cereal flour comprising raw wheat flour, 10 to 100% of which is replaced with a wheat flour substitute for bakery foods comprising swelling-controlled starch and swelling-control free starch.
12. The bakery food as set forth in the foregoing item 11, wherein it is produced using cereal flour comprising raw wheat flour, 20 to 70% of which is replaced with the wheat flour substitute for bakery foods comprising the swelling-controlled starch and the swelling-control free starch.
13. The bakery food as set forth in the foregoing item 11 or 12, wherein wheat gluten is further incorporated into the wheat flour substitute for bakery foods comprising the swelling-controlled starch and the swelling-control free starch.

### EFFECTS OF THE INVENTION

According to the present invention, the simultaneous use of swelling-controlled starch and swelling-control free starch in combination can reduce the stickiness of the dough encountered when preparing bakery foods and permits the production of bakery foods excellent in the feeling to the palate (palatability), and taste and texture as compared with those observed for the foods containing swelling-controlled starch.

In addition, the quality such as palatability, and taste and texture of the final product prepared using the wheat flour substitute can efficiently and synergistically be improved by the simultaneous use of swelling-controlled starch, in particular, phosphate-crosslinked starch and swelling-control free starch, in particular, hydroxypropyl starch or hydroxypropylated phosphate-crosslinked starch in the formulations of bakery foods.

Furthermore, the hydroxypropyl starch and hydroxypropylated phosphate-crosslinked starch comprise SDF in proportion to the degree of processing of the same and therefore, the use thereof permits the improvement of the quality of the resulting bakery foods and does not result in any substantial reduction of the content of TDF in the resulting foods. In addition, the use thereof may rather increase the content of SDF and accordingly, it is expected that desired physiological effects can certainly be accomplished. In this respect, the swelling-controlled starch is almost free of SDF.

### BEST MODE FOR CARRYING OUT THE INVENTION

The term “bakery foods” used herein means one obtained by adding at least water, common salt and/or a substance capable of generating gas or forming pores to raw cereal flour mainly comprising wheat flour and optionally cereal flour such as powder of whole wheat grain, rye flour, corn flour, buckwheat flour, and/or rice flour, further adding secondary materials required for the production of each particular food to the resulting mixture to thus form dough or batter and then cooking the same with heating to give a food having a moisture content ranging from about 2 to 50%, in which large and small bubbles or voids are formed by the action of yeast, baking powder, whole egg or egg white prior to or during the cooking of the dough through heating.

Specific examples thereof are those baked in an oven, for instance, breads such as Pullman, British bread, and one loaf; French breads such as Baguette, Parisian; various kinds of rolls such as sweet rolls, bans, and table rolls; buns such as bean-jam bun, melon-tasted bun; crescent, various kinds of Danish pastries, English muffin, bagel, pizza, naan; foods fried in oil such as doughnuts, fritters; steam-cooked foods such as steam-cooked breads, and Chinese buns. In this connection, the secondary materials used herein include, for instance, those currently used in the production of bakery foods such as saccharides (sugars), dairy products, fats and oils, emulsifying agents, flavor, spices, artificial sweetening agents, coloring agents, Western liquors, dried fruits such as raisin, nuts, and cocoa powder. Moreover, the bakery foods of the present invention can be applied even to the refrigerated dough and frozen dough recently employed for such reasons as rationalization of the production processes and the circulation or distribution of the products. Moreover, foods obtained by subjecting the foregoing foods to a fabrication step such as bread crumbs and rusk are likewise included in the bakery foods of the present invention. As the bakery foods particularly recommended in the present invention, there may be listed, for instance, breads.

The term “wheat flour substitute” used herein means one capable of being used instead of wheat flour serving as a principal raw material used in the bakery foods according to the commonly known formulation. The wheat flour used in such formulation may be hard flour, medium flour and soft flour or a mixture thereof. The wheat flour substitute of the present invention can likewise be applied to foods derived from bakery foods whose principal ingredient is wheat flour such as whole wheat grain flour bread, rye flour bread and rice flour bread.

The term “swelling-controlled starch” used in the invention means the starch which has been modified according to any appropriate method for the purpose of controlling the degree of swelling of starch particles when gelatinizing the same through heating. In this respect, the degree of swelling of the starch is preferably not more than 10, and the degree of swelling thereof is more preferably not more than 5. If the degree of swelling exceeds 10, the starch powder has such a tendency that the IDF content thereof is reduced.

The raw material for the swelling-controlled starch is not particularly restricted and it may be selected from the group consisting of wheat, tapioca, high amylose corn, potato, corn, sago, beans, and waxy corn, which may be used alone or in any combination.

As specific modifying methods for the preparation of such swelling-controlled starch, there may be listed, for instance, the crosslinking technique, the wet heat-treating technique and the retrograding technique. Moreover, these modified starch materials may further be subjected to a pre-gelatinization treatment, an oxidization treatment, a treatment with an enzyme, a treatment with an emulsifying agent, or any combination thereof. Among the foregoing swelling-controlled starch materials, preferably used herein is phosphate-crosslinked starch material.

Specific examples of such swelling-controlled starch materials include NOVELOSE 240 (available from National Starch and Chemical Company; a high amylose starch product), NOVELOSE 260 (available from National Starch and Chemical Company; a high amylose starch product), FiberSym 70 (available from MGP Ingredients, Inc.; a phosphate-crosslinked starch product), FiberSym 80ST (available from MGP Ingredients, Inc.; a phosphate-crosslinked starch product), ROADSTAR (available from Nippon Shokuhin Kako Co., Ltd.; a wet heat-treated starch product).

The term “swelling-control free starch” used herein means un-processed starch materials or processed starch materials whose degree of swelling is preferably higher than 15.

The raw material for the swelling-control free starch is not restricted to any particular one and it may be selected from the group consisting of wheat, tapioca, high amylose corn, potato, corn, sago, beans, waxy corn, rice and glutinous rice which may be used alone or in any combination.

Preferably used herein as such swelling-control free starch materials include hydroxypropyl starch and hydroxypropylated phosphate-crosslinked starch, as well as other starch materials subjected to an esterification treatment, a weak phosphate-crosslinking treatment which does not control the swelling of the starch, an etherified-crosslinking treatment, an esterified-crosslinking treatment, a pre-gelatinization treatment, an oxidation treatment, a treatment with an enzyme, a treatment with an emulsifying agent or a treatment comprising any combination thereof.

In this connection, the degree of swelling is determined according to the following method:

### <Degree of Swelling>

Each sample (1.0 g each) (weighed after drying) was dispersed in 100 mL of water, followed by heating the resulting dispersion at 90° C. for 30 minutes to thus pre-gelatinize the sample and the subsequent cooling of the pre-gelatinized sample to 30° C. Then the pre-gelatinized liquid is centrifuged (at 3000 rpm, for 10 minutes) to thus separate the liquid into a supernatant and a gel phase, the latter is weighed and this weight is referred to as A. Then the weighed gel phase is dried to dryness (heated at 105° C. till a dried product can be obtained, which has a constant weight), the weight of the dried gel is determined and this weight is referred to as B. Thus, the degree of swelling of each sample is defined to be A/B.

In addition, the contents of dietary fibers (SDF, IDF and TDF) are determined according to the following methods:

### <Determination of SDF and IDF Contents>

The officially approved method (AOAC2001. 03) for the determination of the content of the total dietary fibers or TDF is partially modified to thus determine the contents of SDF and IDF. More specifically, the modified method is as follows:

Two beakers per each sample are provided for the protein content-determination and for the ash content-determination. A starch sample (1 g) is dispersed in 50 mL of a 0.08M phosphate buffer solution having a pH value of 6.0 contained in a 500 mL tall beaker and then 100 μL of a thermally stable α-amylase (THERMAMYL 120L available from NovoNordisk Company) is added to the foregoing dispersion. This beaker is covered with an aluminum foil, introduced into a boiling water bath and allowed to stand for 30 minutes, while stirring the same at intervals of 5 minutes. After cooling the same down to room temperature, the pH value thereof is controlled to 7.5^{±0.1} by the addition of a 0.275M NaOH aqueous solution and then 100 μL of a protease (P-5380 available from Sigma Company) is added to the dispersion. The enzyme reaction is continued for 30 minutes, while shaking the reaction system in a water bath maintained at 60° C. The reaction system is then cooled to room temperature, the pH value thereof is controlled to 4.3±0.3 by the addition of a 0.325M HCl aqueous solution, followed by the addition of 100 μL of an amylo-glucosidase (A-9913 available from Sigma Company) and the subsequent reaction of the resulting mixture for 30 minutes, while shaking the reaction system in a water bath maintained at 60° C. The reaction system is suction-filtered through a glass filter (funnel-type one, 1lG2) covered with Celite (1.1 g). The filter together with residues adhered thereto is dried overnight at 105° C., followed by allowing the same to cool and the subsequent determination of the mass of the residues.

The Celite and the residues are scratched off from one of the filters thus treated, the nitrogen content thereof is determined according to the Kjeldahl method to thus determine the protein content of the sample. The residues adhered to the other of the filters is ashed by heating the filter together with the Celite and the residues at a temperature of 525° C. for 5 hours to thus determine the ash content of the sample. Separately, the same procedures used above are repeated without using any sample as a blank test. Thus, the insoluble dietary fibers or IDF can be defined to be the mass obtained by subtracting the protein and nitrogen contents from the dried residues while taking into consideration the results obtained in the blank test. On the other hand, the filtrate is concentrated using an evaporator, the resulting concentrate is washed out with 50 mL of distilled water, followed by the addition of an aqueous glycerin solution corresponding to 100 mg of glycerin as an internal standard substance, desalting of the mixture using an ion-exchange resin for desalting, and the subsequent concentration of the desalted product to a constant volume of 10 mL. The resulting concentrate is filtered through a membrane filter (pore size: 0.20 μm) and then analyzed by HPLC to thus give each corresponding chromatogram. The conditions used for the HPLC analysis are as follows:

### HPLC Conditions:

Column Used: A column comprising two TSK-GEL G2500PWXL (7.8×300 mm) connected in series (available from Tosoh Corporation);
Mobile Phase Pure water (0.5 mL/min);

### Detection: Refractive Index.

The mass calculated on the basis of the peak areas observed for the glycerin as the internal standard substance and the dietary fiber fraction (trisaccharides and higher saccharides) is defined to be the content of the water-soluble dietary fibers or SDF. On the other hand, TDF can be calculated from and expressed in terms of the sum of SDF and IDF.

The ratio, by mass, of the swelling-controlled starch to the swelling-control free starch used in the present invention preferably ranges from 10:90 to 80:20 and more preferably 20:80 to 50:50 and the resulting mixture is used as the wheat flour substitute in the present invention. In this respect, if the ratio is beyond the range specified above or the range of from 10:90 to 80:20, the resulting wheat flour substitute would have such a tendency that it is insufficient in the effect expected when simultaneously using the swelling-controlled starch and the swelling-control free starch.

The combinations of starch materials particularly or highly recommendable in the present invention are those comprising phosphate-crosslinked starch materials as the swelling-controlled starch with hydroxypropylated phosphate-crosslinked starch materials as the swelling-control free starch. The use of such a combination permits the production of bakery foods excellent in the palatability, and taste and texture due to the synergistic effect of these components.

When using the wheat flour substitute in the present invention, the substitute is replaced with 10 to 100% and more preferably 20 to 70% of the wheat flour used in each bakery food as the principal ingredient. In this connection, it is also possible to add a desired amount of gluten in proportion to the degree of such substitution and depending on each particular product or food.

In the bakery foods, there have in general been used various kinds of materials for a variety of purposes, in addition to the basic materials such as common salt, yeast, yeast foods, sugar, fats and oils, egg, and skimmed milk powder. Examples of such additional materials include dairy products such as whole milk, condensed milk, and cheese; sugars and dextrin such as glucose, sorbit, starch syrup, honey, isomerized sugars, oligo saccharides, reduced starch hydrolyzed products, and maltodextrins; emulsifying agents such as glycerin fatty acid esters, sucrose fatty acid esters, and lecithin; proteins such as gluten, soybean proteins, egg yolk, and egg white; polysaccharides such as gellan gum, carrageenan, sodium alginate, and corn starch; enzymes such as proteases and amylases; and dried fruits such as raisin; as well as Western liquors, spices, artificial sweetening agents, coloring agents, emulsifying agents, flavoring compounds, vegetables, fruits, nuts, and cocoa powder; and preservatives. These optional or additional components may, if necessary, be used in the present invention.

Although there have been known and proposed a large number of methods for preparing bakery foods and there have likewise been known a large number of and various kinds of products, the bakery foods of the present invention are essentially produced according to any conventionally known methods and under the same production conditions conventionally used. More specifically, the purposes of the present invention can be accomplished by replacing a predetermined amount, and preferably 10 to 100%, of the raw wheat flour required for each particular bakery food with the wheat flour substitute according to the present invention, in the conventional method for the preparation of the food. At this stage, the wheat flour substitute of the present invention has water-retention properties higher than the wheat flour and accordingly, it is preferred to increase the added amount of water by about 2 to 25% of that conventionally used in order to prepare dough which is in a preferred condition. In general, when increasing the amount of water to be added, the ability of shaping the resulting dough may be deteriorated and the working properties thereof are thus impaired, but the present invention is almost free of any such drawback. More specifically, the use of an increased amount of water when preparing dough is quite favorable in the present invention and this rather results in the improvement of the yield of the dough thus formed.

### EXAMPLES

The present invention will hereunder be described in more detail with reference to the following Reference Examples and Examples, but the present invention is not restricted to these specific Examples at all. In the following Examples, the term “part” used means “part by mass” unless otherwise specified.

### Reference Example 1

To 140 parts of water, there were added 10 parts of sodium sulfate and 100 parts of wheat flour to thus prepare a slurry, then 7 parts of sodium trimetaphosphate was added to the slurry while adjusting the pH value of the slurry to a level of 11.1 to 11.5 by the addition of a 3% aqueous sodium hydroxide solution, with stirring, to thus make them react with one another at 45° C. for 17 hours, the reaction system was neutralized with sulfuric acid, washed with water, dehydrated and then dried to thus give a swelling-controlled starch product No. 1 (crosslinked starch).

Separately, the same procedures used above were repeated except for using 130 parts of water and high amylose corn starch in place of the wheat flour to thus give a swelling-controlled starch product No. 2 (crosslinked starch).

In addition, high amylose corn starch was subjected to an autoclave treatment at 120° C. for 60 minutes to thus give a swelling-controlled starch product No. 3 (wet heat-treated starch).

On the other hand, commercially available phosphate-crosslinked starch derived from corn and phosphate-crosslinked starch derived from tapioca were subjected to pre-gelatinization treatments and the resulting products were defined to be swelling-controlled starch products Nos. 4 and 5, respectively.

Moreover, commercially available NOVELOSE 240 (available from National Starch and Chemical Company.) was used as a swelling-controlled starch product No. 6.

These swelling-controlled starch products were inspected for the degree of swelling (Deg. of Swel.) and the contents of dietary fibers (SDF, IDF). The results thus obtained are summarized in the following Table 1.

TABLE 1

| | Deg. of | IDF Content | SDF Content |
|---|---|---|---|
| Sample | Swel. | (%) | (%) |
| Swelling-Controlled Starch No. 1 | 2.73 | 85.0 | ND* |
| Swelling-Controlled Starch No. 2 | 3.38 | 93.7 | ND |
| Swelling-Controlled Starch No. 3 | 4.46 | 68.0 | ND |
| Swelling-Controlled Starch No. 4 | 4.19 | 20.1 | ND |
| Swelling-Controlled Starch No. 5 | 7.66 | 11.9 | ND |
| Swelling-Controlled Starch No. 6 | 3.11 | 68.8 | ND |

*ND: Not Detected.

### Reference Example 2

To 130 parts of water, there were added 20 parts of sodium sulfate and 100 parts of potato starch to thus prepare a slurry. To the resulting slurry, there were then added 30 parts of a 3% aqueous sodium hydroxide solution, and 0.1 part of phosphorus oxychloride and then they were reacted with one another at 40° C. for one hour. To the resulting sample, there was added 10 parts of propylene oxide, the resulting mixture was reacted with one another at 40° C. for 20 hours, the reaction system was neutralized with a hydrochloric acid solution, washed with water, dehydrated and then dried to thus give a swelling-control free starch product No. 1 (hydroxypropylated phosphate-crosslinked starch).

In this respect, the swelling-control free starch product No. 1 was analyzed and it was found to have a degree of swelling (Deg. of Swel.) of 33.0 and an SDF content of 51.7%, and any IDF was not detected at all.

### Reference Example 3

The same procedures used in Reference Example 2 were repeated except for using tapioca starch instead of the potato starch used therein to thus give a swelling-control free starch product No. 2 (hydroxypropylated phosphate-crosslinked starch).

The swelling-control free starch product No. 2 thus prepared was analyzed and it was found to have a degree of swelling (Deg. of Swel.) of 24.9, an SDF content of 40.3% and an IDF content of 1.02%.

### Example 1

Mountain-shaped bread was prepared by way of trial according to the bread-producing formulation shown in the following Table 2 prepared under the conditions as specified in the following Table 3. Moreover, wheat flour substitutes were prepared according to the formulations specified in the following Table 4.

Seven panelists were requested for the evaluation of and the inspection of each bread sample for the following items: mixing properties; conditions of dough on its moulding and panning; the appearance and crumb of each sample; the taste and texture of the sample; the smoothness of the sample; the softness thereof; and the disintegration ability in the mouth. Each item was evaluated on the basis of the following 10-stage evaluation criteria: 1 (undesirable) to 10 (most desirable). The sensory characteristics (the taste and texture of the sample; the smoothness of the sample; the softness thereof; and the disintegration ability in the mouth) of the sample were examined on the day subsequent to the production of each sample.

The results obtained in the bread-production tests are listed in Table 4. As a result, it was found that all of the foregoing items for evaluation are improved as compared with those observed for the control. In this respect, the mountain-shaped bread prepared in this Example was found to have a content of the wheat flour substitute of about 11 g per 100 g of the bread as calculated on the basis of the mass of the resulting bread and each formulation specified in Table 2. Accordingly, this clearly indicates that if the TDF content of the wheat flour substitute exceeds 50%, the resulting mountain-shaped bread has a TDF content of not less than 5 g per 100 g of the bread. The recommended intake of dietary fibers is set at a level of 20 to 25 g per day for adult and therefore, the foregoing TDF content is considered to be sufficient for the achievement of the desired effect thereof.

TABLE 2

| | |
|---|---|
| Raw Materials for Making Bread | Amt. (part) |

Sponge-Making Step

| | |
|---|---|
| Hard wheat flour | 50 |
| Yeast | 2 |
| Yeast food | 0.1 |
| Water | 31 |

Dough-Making Step

| | |
|---|---|
| Wheat flour substitute | 50 |
| Gluten | 7.6 |
| Soft sugar | 6 |
| Skimmed milk powder | 2 |
| Common salt | 2 |
| Yeast | 1 |
| Shortening | 6 |
| Water | As much as suffices (q.s.) |

TABLE 3
Sponge-Making Step

| | |
|---|---|
| Mixing | 3 minutes at a low speed, one minute at a high speed |
| Kneading Temp. | 24° C. |
| Fermentation time | 4 hours |

Dough-Making Step

| | |
|---|---|
| Mixing | 3 minutes at a low speed, 2 minutes at a high speed |
| | (addition of shortening); |
| | 2 minutes at a low speed, 2 minutes at a high speed |
| Kneading Temp. | 28° C. |
| Floor time | 15 minutes |
| Mass of divisions | 250 g × 2 pieces/case |
| Bench time | 20 minutes |
| Moulding and | After degassing, the dough is elongated in a rod-like |
| panning | shape, then formed into the Japanese character |
| | [symbol] and packed in a case (size: 1.5 kin) |
| Proof | At an instance when the dough was expanded and |
| | reached up to a height of 5 mm above the case |
| | (38° C., 80%) |
| Baking | 26 minutes (upper flame: 180° C.; lower flame: |
| | 205° C.) |

TABLE 4

| | Wheat flour substitute No. | | | |
|---|---|---|---|---|
| | 1 | 2 | 3 | Control |
| Swelling-controlled starch No. 1 | 20% | 50% | 80% | 100% |
| Swelling-control free starch No. 1 | 80% | 50% | 20% | — |
| TDF content of wheat flour substitute | 58% | 68% | 78% | 85% |
| Mixing properties | 7 | 7 | 3 | 1 |
| Conditions of dough on its moulding and | 7 | 8 | 4 | 1 |
| panning | | | | |
| Appearance and crumb | 8 | 8 | 4 | 1 |
| Taste and texture | 6 | 6 | 4 | 1 |
| Smoothness feeling | 6 | 6 | 3 | 1 |
| Softness feeling and disintegration ability | 7 | 7 | 4 | 2 |
| in the mouth | | | | |
| Total score | 41 | 42 | 22 | 7 |

### Example 2

In this Example, the same procedures used in Example 1 were repeated except that wheat flour substitutes used were prepared according to the formulations specified in the following Table 5 to thus carry out bread-making tests. The results obtained in the bread-making tests are listed in Table 5. As a result, it was found that the bread-making ability and the quality of the resulting product were distinctly improved as compared with those observed for the control. In addition, the total scores observed for the product of the present invention were found to be higher than that obtained for the control. In other words, these results clearly indicate that the simultaneous use of the swelling-controlled starch and the swelling-control free starch results in the achievement of a synergistic effect. Furthermore, the wheat flour substitute No. 4 and the control product were inspected for the sensory characteristics (the taste and texture of the sample; the smoothness of the sample; the softness thereof; and the disintegration ability in the mouth), after 3 days and 5 days from the trial production thereof. The results obtained in these tests are summarized in the following Table 6. As a result, it was found that the degree of decrease, with time, in the product's quality and characteristics is small as compared with that observed for the control.

TABLE 5

| | Wheat flour | | |
|---|---|---|---|
| | substitute No. | | |
| | | | Comp. |
| | 4 | Control | Ex. |
| Swelling-controlled starch No. 2 | 50% | 100% | — |
| Swelling-control free starch No. 1 | 50% | — | 100% |
| TDF content of wheat flour substitute | 72% | 93% | 51% |
| Mixing properties | 9 | 5 | 8 |
| Conditions of dough on its moulding and | 9 | 6 | 7 |
| panning | | | |
| Appearance and crumb of product | 9 | 7 | 7 |
| Taste and texture of product | 9 | 6 | 7 |
| Smoothness feeling of product | 8 | 4 | 10 |
| Softness feeling and disintegration ability in the | 9 | 5 | 5 |
| mouth observed for product | | | |
| Total score | 53 | 33 | 44 |

TABLE 6

| Wheat flour | |
|---|---|
| substitute | |
| No. | |
| 4 | Control |

3 Days after trial manufacture

| | | |
|---|---|---|
| Taste and texture of product | 8 | 5 |
| Smoothness feeling of product | 8 | 3 |
| Softness feeling and disintegration ability in the mouth | 9 | 3 |
| observed for product | | |

5 Days after trial manufacture

| | | |
|---|---|---|
| Taste and texture of product | 8 | 3 |
| Smoothness feeling of product | 7 | 2 |
| Softness feeling and disintegration ability in the mouth | 8 | 2 |
| observed for product | | |

### Example 3

In this Example, the same procedures used in Example 1 were repeated except that wheat flour substitutes used were prepared according to the formulations specified in the following Table 7 to thus carry out bread-making tests. In Table 7, the swelling-control free starch used herein was hydroxypropylated phosphate-crosslinked starch derived from tapioca starch. The results obtained in the bread-making tests are listed in Table 7.

TABLE 7

| | Wheat flour substitute No. | | | |
|---|---|---|---|---|
| | 5 | Control | 6 | Control |
| Swelling-controlled starch No. 3 | 50% | 100% | | |
| Swelling-controlled starch No. 4 | | | 50% | 100% |
| Swelling-control free starch No. 2 | 50% | | 50% | |
| Mixing properties | 3 | 2 | 5 | 3 |
| Conditions of dough on its moulding and panning | 5 | 5 | 5 | 2 |
| Appearance and crumb of product | 8 | 7 | 6 | 4 |
| Taste and texture of product | 8 | 3 | 6 | 2 |
| Smoothness feeling of product | 6 | 2 | 7 | 2 |
| Softness feeling and disintegration ability, in the | 8 | 5 | 7 | 4 |
| mouth, observed for product | | | | |
| Total score | 38 | 24 | 36 | 17 |
| | Wheat flour substitute No. | | | |
| | 7 | Control | 8 | Control |
| Swelling-controlled starch No. 5 | 50% | 100% | | |
| Swelling-controlled starch No. 6 | | | 50% | 100% |
| Swelling-control free starch No. 2 | 50% | | 50% | |
| Mixing properties | 5 | 4 | 3 | 2 |
| Conditions of dough on its moulding and panning | 6 | 5 | 3 | 2 |
| Appearance and crumb of product | 8 | 6 | 6 | 4 |
| Taste and texture of product | 8 | 6 | 6 | 1 |
| Smoothness feeling of product | 8 | 5 | 5 | 1 |
| Softness feeling and disintegration ability, in the | 8 | 6 | 6 | 3 |
| mouth, observed for product | | | | |
| Total score | 43 | 32 | 29 | 13 |

### Example 4

In this Example, the same procedures used in Example 1 were repeated except that wheat flour substitutes used were prepared according to the formulations specified in the following Table 8 to thus carry out bread-making tests. The results obtained in the bread-making tests are listed in Table 8. As a result, it was found that the bread-making ability and the quality of the resulting product were distinctly improved as compared with those observed for the control, irrespective of the kinds of modifying methods selected for the swelling-control free starch. Moreover, acetylated phosphate-crosslinked starch was likewise used as the swelling-control free starch and it was confirmed that the simultaneous use thereof with the swelling-controlled starch could achieve a synergistic effect of improving the quality of the product.

TABLE 8

| | Wheat flour substitute No. | | | |
|---|---|---|---|---|
| | 9 | 10 | 11 | 12 |
| Swelling-controlled starch No. 2 | 20% | 20% | 20% | 20% |
| Hydroxypropylated phosphate-crosslinked starch | 80% | | | |
| Hydroxy-propyl starch | | 80% | | |
| Starch acetate | | | 80% | |
| Acetylated phosphate-crosslinked starch | | | | 80% |
| Oxidized starch | | | | |
| Mixing properties | 8 | 8 | 7 | 7 |
| Conditions of dough on its moulding and panning | 8 | 7 | 8 | 6 |
| Appearance and crumb of product | 10 | 10 | 10 | 10 |
| Taste and texture of product | 9 | 9 | 8 | 8 |
| Smoothness feeling of product | 10 | 10 | 10 | 10 |
| Softness feeling and disintegration ability in the | 9 | 8 | 9 | 9 |
| mouth, observed for product | | | | |
| Total score | 54 | 52 | 52 | 50 |
| | Wheat flour substitute No. | | | |
| | 13 | Comp. Ex. | 14 | Control |
| Swelling-controlled starch No. 2 | 50% | | 20% | 100% |
| Acetylated phosphate-crosslinked starch | 50% | 100% | | |
| Oxidized starch | | | 80% | |
| Mixing properties | 7 | 6 | 7 | 5 |
| Conditions of dough on its moulding and | 6 | 6 | 7 | 6 |
| panning | | | | |
| Appearance and crumb of product | 10 | 9 | 10 | 7 |
| Taste and texture of product | 7 | 7 | 7 | 6 |
| Smoothness feeling of product | 10 | 10 | 10 | 4 |
| Softness feeling and disintegration ability in | 8 | 5 | 9 | 5 |
| the mouth, observed for product | | | | |
| Total score | 48 | 43 | 50 | 33 |

### Example 5

The same procedures used in Example 1 were repeated except for using the formulations as set forth in the following Tables 9 and 10 to thus carry out the bread-making tests. The results obtained in the foregoing bread-making tests are listed in Table 10 given below.

TABLE 9

| | |
|---|---|
| Ingredients for bread-making | Amt. (part) |

Sponge-making step

| | |
|---|---|
| Hard wheat flour | Specified in |
| Wheat flour substitute | Table 10 |
| Gluten | |
| Yeast | 2 |
| Yeast food | 0.1 |
| Water | 31 |

Dough-making step

| | |
|---|---|
| Hard wheat flour | Specified in |
| Wheat flour substitute | Table 10 |
| Gluten | |
| Soft sugar | 6 |
| Skimmed milk powder | 2 |
| Common salt | 2 |
| Yeast | 1 |
| Shortening | 6 |
| Water | q.s. |

TABLE 10

| Wheat flour substitute No. | | | | | |
|---|---|---|---|---|---|
| 15 | Cont. | 16 | Cont. | 17 | Cont. |

Sponge-making step

| | | | | | | |
|---|---|---|---|---|---|---|
| Hard wheat flour | 50 | 50 | 20 | 20 | | |
| Swelling-controlled starch No. 2 | | | 15 | 30 | 25 | 50 |
| Swelling-control free starch | | | 15 | | 25 | |
| No. 1 | | | | | | |
| Gluten | | | 4.5 | 4.5 | 7.5 | 7.5 |

Dough-making step

| | | | | | | |
|---|---|---|---|---|---|---|
| Hard wheat flour | 30 | 30 | | | | |
| Swelling-controlled starch No. 2 | 10 | 20 | 25 | 50 | 25 | 50 |
| Swelling-control free starch | 10 | | 25 | | 25 | |
| No. 1 | | | | | | |
| Gluten | 3 | 3 | 7.6 | 7.6 | 7.6 | 7.6 |
| Mixing properties | 10 | 8 | 5 | 1 | 3 | 1 |
| Conditions of dough on its | 10 | 7 | 6 | 3 | 4 | 3 |
| moulding and panning | | | | | | |
| Appearance and crumb of | 10 | 9 | 6 | 4 | 4 | 2 |
| product | | | | | | |
| Taste and texture of product | 10 | 8 | 4 | 1 | 2 | 1 |
| Smoothness feeling of product | 10 | 7 | 4 | 1 | 2 | 1 |
| Softness feeling and | 10 | 8 | 3 | 1 | 2 | 1 |
| disintegration, ability in the | | | | | | |
| mouth, of product | | | | | | |
| Total score | 60 | 47 | 28 | 11 | 17 | 9 |

### Example 6

Buns with a bean-jam filling were prepared, by way of trial, using the formulations for the Chinese bun specified in the following Table 11 according to the usual production conditions. The resulting products were evaluated according to the evaluation method used in Example 1. The results obtained are summarized in the following Table 12. The products of the present invention were evaluated to be excellent in the handling properties on the manufacture thereof, the smoothness feeling of product and the softness feeling and disintegration ability in the mouth, as compared with those observed for the control.

TABLE 11

| | | | Comp. | Comp. |
|---|---|---|---|---|
| | Ex. 6 | Cont. | EX. 1 | Ex. 2 |
| Special grade hard wheat flour | 25 | 25 | 25 | 25 |
| Special grade soft wheat flour | 45 | 45 | 45 | 75 |
| Swelling-controlled starch No. 2 | 15 | 30 | | |
| Swelling-control free starch No. 1 | 15 | | 30 | |
| Subtotal | 100 | 100 | 100 | 100 |
| Soft sugar | 10 | 10 | 10 | |
| Baking powder *1 | 0.5 | 0.5 | 0.5 | 0.5 |
| Common salt | 0.1 | 0.1 | 0.1 | 0.1 |
| Dry yeast *2 | 1.5 | 1.5 | 1.5 | 1.5 |
| Water | 45.0 | 45.0 | 45.0 | 45.0 |
| Lard | 10.0 | 10.0 | 10.0 | 10.0 |
| Total | 167.1 | 167.1 | 167.1 | 167.1 |

*1: Top Baking Powder DX available from OKUNO Pharmaceutical Co., Ltd.
*2: Super Camellia Dry Yeast available from Nissin Foods Co., Ltd.

TABLE 12

| | | | Comp. | Comp. |
|---|---|---|---|---|
| | Ex. 6 | Cont. | Ex. 1 | Ex. 2 |
| Mixing properties | 10 | 5 | 8 | 8 |
| Conditions of dough on its moulding | 10 | 5 | 8 | 8 |
| and panning | | | | |
| Appearance and crumb of product | 10 | 6 | 7 | 8 |
| Taste and texture of product | 10 | 4 | 8 | 9 |
| Smoothness feeling of product | 10 | 4 | 10 | 8 |
| Softness feeling and disintegration | 10 | 5 | 6 | 7 |
| ability in the mouth, observed for | | | | |
| product | | | | |
| Total score | 60 | 29 | 47 | 48 |

### Example 7

A wheat flour substitute was prepared by blending the swelling-controlled starch No. 2 with the swelling-control free starch No. 1 in a mixing ratio of 1:1. Separately, the swelling-controlled starch No. 2 was used as the control. Bans, croissants, cakes and doughnuts were produced, by way of trial, using each corresponding formulation commonly used in this field while the wheat flour substitute prepared above in advance was replaced with 30% of the raw wheat flour of each product. As a result, all of the products prepared above were found to be excellent in the smoothness feeling and the softness feeling and disintegration ability in the mouth.

What is claimed is:

1. A method of improving quality of bread containing a swelling-controlled starch, comprising replacing 20-70% of wheat flour with a wheat flour substitute, wherein said wheat flour substitute comprises a swelling-controlled starch and a swelling-control free starch.

2. The method as set forth in claim 1, wherein the degree of swelling of the swelling-controlled starch is not more than 10.

3. The method as set forth in claim 1, wherein the degree of swelling of the swelling-controlled starch is not more than 5.

4. The method as set forth in claim 1, wherein the swelling-controlled starch is phosphate-crosslinked starch or wet heat-treated starch.

5. The method as set forth in claim 1, wherein the degree of swelling of the swelling-control free starch is not less than 15.

6. The method as set forth in claim 5, wherein the swelling-control free starch is at least one member selected from the group consisting of hydroxypropyl starch, hydroxypropylated phosphate-crosslinked starch, starch acetate, acetylated phosphate-crosslinked starch, and oxidized starch.

7. The method as set forth in claim 5, wherein the swelling-control free starch is hydroxypropyl starch and/or hydroxypropylated phosphate-crosslinked starch.

8. The method as set forth in claim 1, wherein the mixing ratio of the swelling-controlled starch to the swelling-control free starch ranges from 10:90 to 80:20.

9. The method as set forth in claim 8, wherein the mixing ratio of the swelling-controlled starch to the swelling-control free starch ranges from 20:80 to 50:50.

10. The method as set forth in claim 1, wherein wheat gluten is incorporated into the wheat flour substitute.

11. The method as set forth in claim 1, wherein the bread is selected from the group consisting of pullman, British bread, French breads, rolls, buns, crescent, Danish pastries, English muffin, and bagel.
